(19) United States
(12) Patent Application Publication
(10) Pub. No.: US 2020/0238296 A1
(43) Pub. Date: Jul. 30, 2020

(54) Vortex device for disintegrating material

(71) Applicant: Viktor SHOSTAK, Poltava (UA)

(72) Inventor: Viktor SHOSTAK, Poltava (UA)

(21) Appl. No.: 16/639,643

(22) PCT Filed: Oct. 31, 2017
(86) PCT No.: PCT/UA17/00105

§ 371 Date: Feb. 17, 2020

(30) Foreign Application Priority Data
Sep. 20, 2017 (UA) A 2017 09262

(51) Int. Cl. B02C 19/06; B02C 19/00

(52) U.S. Cl. CPC B02C 19/061; B02C 25/00; B02C 19/065; B02C 19/0056

(57) ABSTRACT

A vortex device for disintegrating a material is intended for preparing fine powders. The device includes a cylinder-like housing (1) having a first inlet aperture (2) and secondary inlet apertures (4) for delivering an energy carrier. Outlet apertures (6) and (7) are disposed in the wall of the housing (1) and in the bottom, and a loading aperture (5) is disposed in a cover. The inlet apertures (2, 4) are configured along the full height of a side wall of the cylinder-like housing (1), moreover, the first inlet aperture (2) is oriented at a lesser angle relative to the radius of the housing (1) than at least two secondary apertures (4) and is opposed to the latter in terms of the direction of delivery of the energy carrier about the axis of the housing. Vortex generators (3) are disposed next to the secondary inlet apertures (4).

### CROSS-REFERENCE TO RELATED APPLICATIONS

This application is a U.S. national phase application of a PCT application PCT/UA2017/000105 filed on 20 Sep. 2017, published as WO2019/059873, whose disclosure is incorporated herein in its entirety by reference, which PCT application claims priority of a Ukrainian patent application UA a2017/09262 filed on 20 Sep. 2017.

### FIELD OF THE INVENTION

The invention relates to the sector of machine building industry, namely the production of devices for the disintegrating material for the chemical, food, building industries and the like with the manufacture of fine powders.

### BACKGROUND OF THE INVENTION

An example of a vortex device for disintegrating material with a cylinder-like housing, in which two concentric vortices are realized, is published in the application KR No. 20040073116 (A), B02C 19/06. A more powerful near-wall vortex has an aperture for the exit of the energy carrier and crushed material in the side wall of the housing, and the vortex inside the first has several apertures for the exit of the energy carrier and crushed material that are located in the bottom around the axis of the cylinder-like housing. This gives an advantage in the possibility of classifying the crushed material by particle size with their simultaneous selection. Also it's expanding technological capabilities to optimize the grinding process. However, there remains a drawback that is associated with the mechanical interaction of the crushed material and the side wall of the housing and its clogging with foreign impurities.

A vortex device for disintegrating material is known (publ. GB No. 1238737 (A), V02C 19/06), which comprises a housing of two arc-like parts connected through side apertures, in the side wall of which there are made inlet apertures for the energy carrier, which in each of these parts located essentially the same with a gradual increase in the angle of inclination to the radius of its side wall. The first and oppositely inclined second energy supply inlets are located on one side of the connected arc-like parts to form input chambers. Contains outlet apertures for energy carrier and crushed material, loading aperture, cover and bottom.

Coincide with the essential features of the vortex device, which is claimed to be a circular-shaped housing, in the side wall of which the first and second inlet apertures for the energy carrier are made, which are inclined opposite to one relative to the direction of rotation around the axis of the circular-shaped housing, outlet apertures for the energy carrier and crushed material, a loading aperture, cover and bottom.

A drawback of the known vortex device is that the material being crushed collides excessively with the surface of the housing, which leads to accelerated wear and clogging of the material being crushed by extraneous impurities.

Known vortex device for grinding material (Pat. UA No. 51728, V02C 19/06), selected as the closest analogue, which contains a cylinder-like housing, in the side wall of which there are first and second inlets for the energy carrier, which are inclined opposite to one another relative to the direction of rotation around the axis of the cylinder-like housing, the outlet for the energy carrier and the crushed material contains, a cover in which a loading aperture is made, and a bottom. Contains n elements of turbulence of the energy carrier flow, which are made as apertures in the partitions that separate the upper part of the cylinder-like housing from the first inlet for the energy carrier from its middle part.

Coincide with the essential features of the vortex device, which is claimed to be a cylinder-like housing, in the side wall of which the first and second energy inlets are made, which are inclined opposite to one relative to the direction of rotation about the axis of the cylinder-like housing. It contains an outlet for the energy carrier and crushed material, a cover in which a loading aperture is made, a bottom, as well as n elements for swirling the energy carrier flow.

A drawback of the known vortex device is the same as that of the previous analogue.

### BRIEF SUMMARY OF THE INVENTION

The basis of the invention is the task of improving the vortex device, in which by design changes to reduce the collision intensity of the crushed material with the surface of the housing, thereby slowing down its wear and reduce the clogging of the crushed material with impurities.

In a vortex device for grinding material, which contains a cylinder-like housing, in the side wall of which the first and second inlets for energy carrier are made, which are inclined opposite to one relative to the direction of rotation around the axis of the cylinder-like housing, the outlet for the energy carrier and crushed material contains a cover, which has a loading aperture, and the bottom, as well as n elements of the swirl of the energy carrier flow, according to the invention, inlets for energy the carriers are made essentially to the entire height of the side wall of the cylinder-like housing, the first inlet apertures for the energy carrier are inclined to the radius of the side wall of the cylinder-like housing at an angle that is less than the angle of inclination to this radius at least two second apertures for the energy carrier, the bottom additionally contains at least three outlet apertures, which located around the axis of the cylinder-like housing.

Besides, the second energy carrier inlets are located in the direction of rotation of the carrier passed through them, substantially close to each of the n swirls, which are located on the inner surface of the side wall of the cylinder-like housing.

Besides, at least one first energy carrier inlet is configured to couple to a first energy carrier, and at least two second energy carrier inlets are coupled to a second carrier that is four times less in power from the first carrier.

The combination of the main features of the vortex device for disintegrating material provides a solution to the problem. The inner surface of the side wall of the cylinder-like housing, which wears out most from intense collisions with the material being crushed, is protected by a near-wall layer of the energy carrier flow with a direction of movement opposite to that of the material being crushed.

### BRIEF DESCRIPTION OF DRAWINGS OF THE INVENTION

In FIG. 1 schematically shows the inventive vortex device for grinding material in a transverse cross-section;

FIG. 2 schematically shows the vortex device in a vertical cross-section.

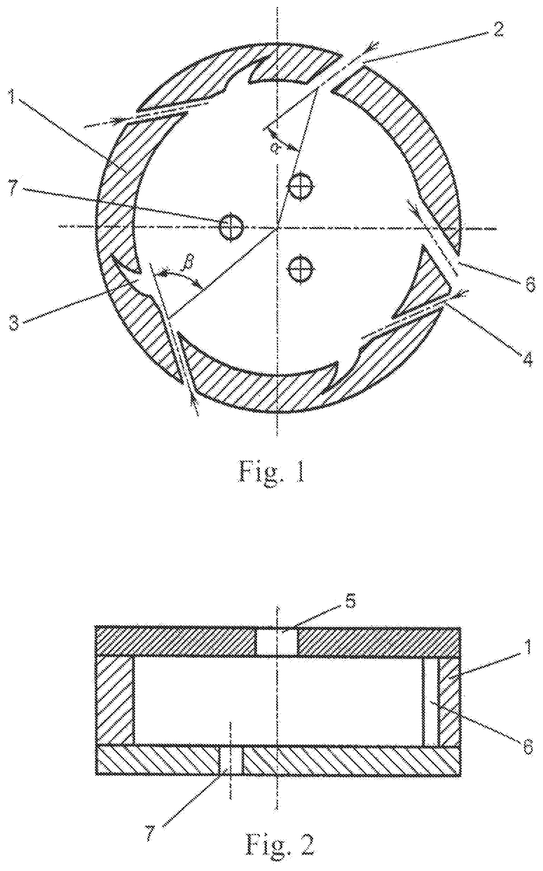

### DETAIL DESCRIPTION OF PREFERRED EMBODIMENTS OF THE INVENTION

The vortex device for grinding material contains a cylinder-like housing 1 with a first inlet aperture 2 for energy carrier, which is inclined to the radius of the cylinder-like housing 1 at an angle α. The swirls 3 are located evenly around the axis of the cylinder-like housing 1 and behind each of them in the direction of movement of the energy carrier from the first inlet aperture 2 there is a second inlet aperture 4 for the energy carrier. The angle of inclination β of each second inlet aperture 4 for the energy carrier to the radius of the cylinder-like housing 1 is greater than the angle α. The loading aperture 5 is located in the middle of the cover of the cylinder-like housing 1. The outlet aperture 6 for the energy carrier and crushed material is located in the side wall of the cylinder-like housing 1 close to the inlet aperture 2 from the side that is opposite to the direction of movement of the energy carrier from it. The bottom contains three outlet apertures 7, which are located around the axis of the cylinder-like housing 1. Apertures 2, 4, 6 and 7 are connected to pipes, which are not shown in the figure.

The proposed vortex device for grinding material works in this way.

Through the first energy carrier inlet aperture 2, a jet of gas carrier, for example air, is supplied to a cylinder-like housing 1, for example, which forms a first circulating stream in this housing in the direction of the arrow in this hole. Through the second energy carrier inlet apertures 4, a jet of the same gas carrier is fed into a cylinder-like housing 1, forms a second circulating flow in this housing in a direction that is opposite to the direction of the first circulating flow. Due to the difference in the angles α and β of the slope of the first and second inlet apertures 2 and 4 for the energy carrier, the second circulating stream is located near the side wall of the cylinder-like housing 1, and the first circulating stream is in close proximity to the second circulating stream from the center of the cylinder-like housing 1.

In order for the first circulating stream to perform the function of a vortex grinder, its power is at least four times powerful of the second circulating stream. Moreover, in the swirls 3 under the influence of the first circulating flow, strong rarefaction zones are formed, which cause the formation of local powerful vortices with a speed in local space that is close to the speed of sound.

The crushed material enters through the loading aperture 5 into the cavity of the cylinder-like housing 1 and rotates around its central axis under the action of the first circulating stream. Crossing the vortex zones, the material being crushed is intensively destroyed and most of it with larger particles of powder exits in the form of powder through the outlet aperture 6. The other part of the finer powder exits through the outlet aperture 7. Because of the counteraction of the second circulating stream, the material being crushed for the whole time grinding does not penetrate into the wall region near the side wall of the cylinder-like housing 1. Due to the location of the inlet apertures 4 near the swirls 3, the vortex regions formed by them, which have the property of expanding, do not reach the side wall of the cylinder-like housing 1 through reaction from the energy flow from these holes. As a result, the side walls of the cylinder-like housing 1 are protected from destruction, the crushed material is much less clogged with impurities of the material of the cylinder-like housing 1, which improves the quality of the proposed device.

The proposed vortex device for grinding material is made in the form of a prototype, which has been successfully tested in the manufacture of various fine powders.

1. A vortex device for disintegrating material, which contains a cylinder-like housing, in the side wall of which the first and second inlet apertures for the energy carrier are made, which are inclined opposite to one relative to the direction of rotation around the axis of the cylinder-like housing, the outlet aperture for the energy carrier and the crushed material contains a cover, in which the loading aperture is made, and the bottom, as well as n elements of the swirl of the energy flow, which is different in that the inlet apertures for the energy carrier is made essentially to the entire height of the side wall of the cylinder-like housing, the first input aperture for the energy carrier are inclined to the radius of the side wall of the cylinder-like housing at an angle that is less than the angle of inclination to this radius of at least two second apertures for the energy carrier, the bottom additionally contains at least three outlet apertures, which located around the axis of the cylinder-like housing.

2. The vortex device according to claim 1, is different in that the second energy carrier inlet apertures are located in the direction of rotation of the carrier passed through them, essentially close to each of the n swirls, which are located on the inner surface of the side wall of the cylinder-like housing.

3. The vortex device according to claim 1, is different in that at least one first inlet aperture for the energy carrier is configured to communicate with the first generator of the energy carrier, at least two second inlet apertures for the energy carrier are configured to communicate with the second generator of the energy carrier, which is at least four times less power from the first energy generator.
